(19) United States
(12) Patent Application Publication
(10) Pub. No.: US 2022/0055273 A1
(43) Pub. Date: Feb. 24, 2022

(54) VALVE-GATING INJECTION MOLDING APPARATUS

(71) Applicant: Mold-Masters (2007) Limited, Georgetown, ON (CA)

(72) Inventors: Peter KLOBUCAR, Georgetown (CA); Denis BABIN, Georgetown (CA)

(21) Appl. No.: 17/417,935

(22) PCT Filed: Dec. 23, 2019
(86) PCT No.: PCT/CA2019/051903

§ 371 Date: Jun. 24, 2021

Related U.S. Application Data
(60) Provisional application No. 62/785,361, filed on Dec. 27, 2018.

(51) Int. Cl. B29C 45/28

(52) U.S. Cl. CPC B29C 45/2806; B29C 2045/2889; B29C 2045/2858

(57) ABSTRACT

A valve-gating injection molding apparatus is disclosed. The valve gating injection molding apparatus has a manifold with a manifold channel extending therethrough and a nozzle coupled to the manifold and having a nozzle channel in fluid communication with the manifold channel A valve pin extends across the manifold and through the nozzle channel. An actuator coupled to the valve pin for translating the valve pin between open and closed positions. A plurality of mold plates forming an enclosure to house the manifold, the plurality of mold plates defining an egress passageway through which the valve pin extends and a diversion chute that intersects the egress passageway at an angle.

### TECHNICAL FIELD

The present invention relates to injection molding apparatus, and more particularly to a valve-gating injection molding apparatus.

### BACKGROUND

Valve-gating injection molding is a process whereby moldable material is injected under pressure through a hot runner system to a mold cavity. Each molding cycle, a valve pin which extends through the hot runner system to a mold gate is moved between a closed position in which the valve pin blocks the mold gate to prevent moldable material from entering the mold cavity and an open position in which the pin is separated from its mold gate to allow moldable material to enter the mold cavity.

Among other things, injection pressure and reciprocating movement of the valve pin can lead to moldable material ingress between the valve pin and a pin bore which seals around the valve pin where it enters a melt channel of the hot runner system. With time, molding material can egress from the hot runner system altogether. This phenomenon is known in the art as valve pin weepage; prolonged accumulation of weepage can adversely affect the performance of the hot runner system. For example, accumulation of weepage can interfere with the valve pin actuator and adversely affect pin movement, or accumulation of weepage can adhere to an outer surface of hot runner system and adversely affect its thermal profile. Eventually, the hot runner system requires servicing to remove the egressed molding material. Since servicing the hot runner system results in lost production time, it is desirable to increase the service interval and/or reduce the time and complexity of removing the egressed molding material.

### SUMMARY

Embodiments hereof are directed to a valve gating injection molding apparatus having a manifold with a manifold channel extending therethrough and a nozzle coupled to the manifold and having a nozzle channel in fluid communication with the manifold channel. A valve pin extends across the manifold and through the nozzle channel. An actuator is coupled to the valve pin for translating the valve pin between open and closed positions. A plurality of mold plates forming an enclosure to house the manifold, the plurality of mold plates defining an egress passageway through which the valve pin extends and a diversion chute intersects the egress passageway at an angle.

### BRIEF DESCRIPTION OF DRAWINGS

The foregoing and other features and advantages of the present disclosure will be apparent from the following description of embodiments thereof as illustrated in the accompanying drawings. The accompanying drawings, which are incorporated herein and form a part of the specification, further serve to explain the principles of the present disclosure and to enable a person skilled in the pertinent art to make and use the invention(s) taught in the present disclosure. The drawings may not be to scale.

FIG. 1 is a sectional view of a valve-gating injection molding apparatus in accordance with an embodiment of the present disclosure.

FIG. 1A is a sectional view of the valve-gating injection molding apparatus of FIG. 1 taken along line A-A of FIG. 1.

FIG. 1B is an enlarged view of a portion B of FIG. 1.

FIG. 2 is a sectional view of a valve-gating injection molding apparatus in accordance with another embodiment of the present disclosure.

FIG. 2A is a sectional view of the valve-gating injection molding apparatus of FIG. 2 taken along line A-A of FIG. 2.

FIG. 2B is an enlarged view of a portion B of FIG. 2.

FIG. 3 is a sectional view of a valve-gating injection molding apparatus in accordance with yet another embodiment of the present disclosure.

FIG. 4 is a sectional view of a valve-gating injection molding apparatus in accordance with yet another embodiment of the present disclosure.

FIG. 4A is a sectional view of the valve-gating injection molding apparatus of FIG. 4 taken along line A-A of FIG. 4.

FIG. 4B is an enlarged view of a portion B of FIG. 4.

FIG. 5 is a sectional view of a valve-gating injection molding apparatus in accordance with yet another embodiment of the present disclosure.

FIG. 5A is an enlarged view of a portion A of FIG. 5.

### DETAILED DESCRIPTION

Specific embodiments of the present disclosure are now described with reference to the figures, wherein like reference numbers indicate identical or functionally similar elements. The following detailed description is merely exemplary in nature and is not intended to limit the disclosure or the application and uses of the disclosure. In the following description, “downstream” is used with reference to the general direction of mold material flow from an injection unit to a mold cavity of an injection molding system and also to the order of components, or features thereof through which the mold material flows, from an inlet of the injection molding system to a mold cavity, whereas “upstream” is used with reference to the opposite direction. Also, in the following description, “forward” is used with reference to the direction towards the mold cavity and “rearward” is used with reference to the direction away from the mold cavity. Furthermore, there is no intention to be bound by any expressed or implied theory presented in the preceding technical field, background, summary or the following detailed description.

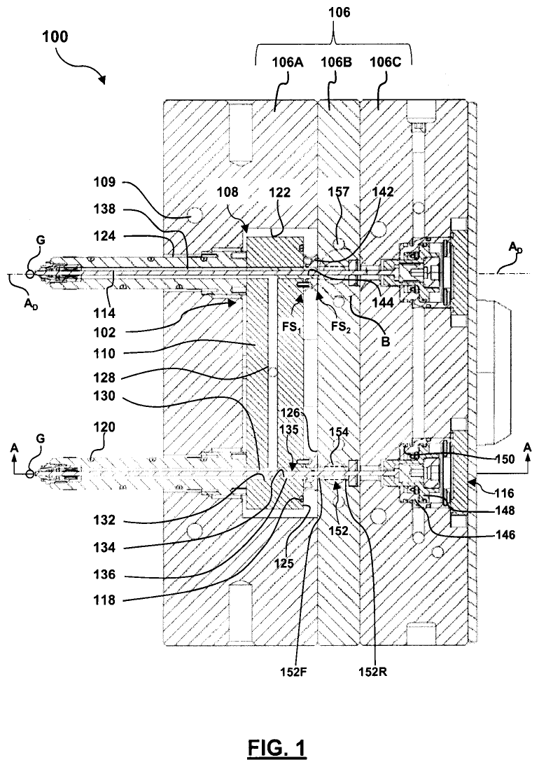

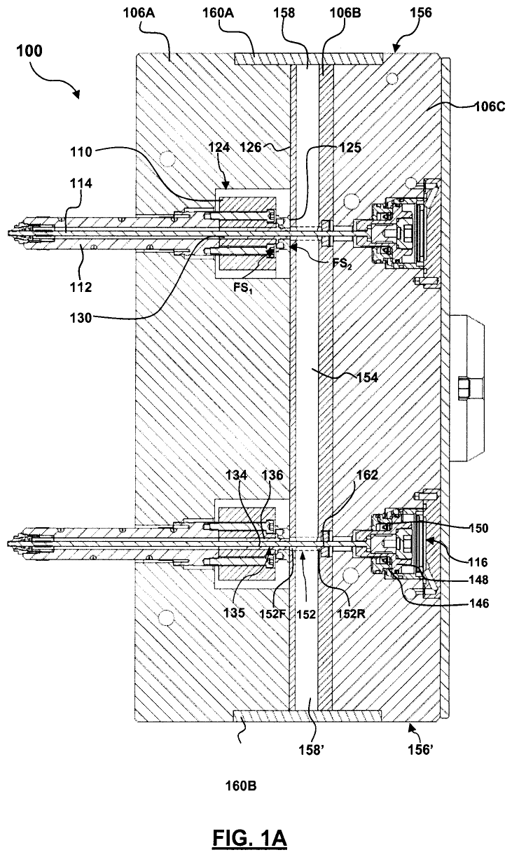

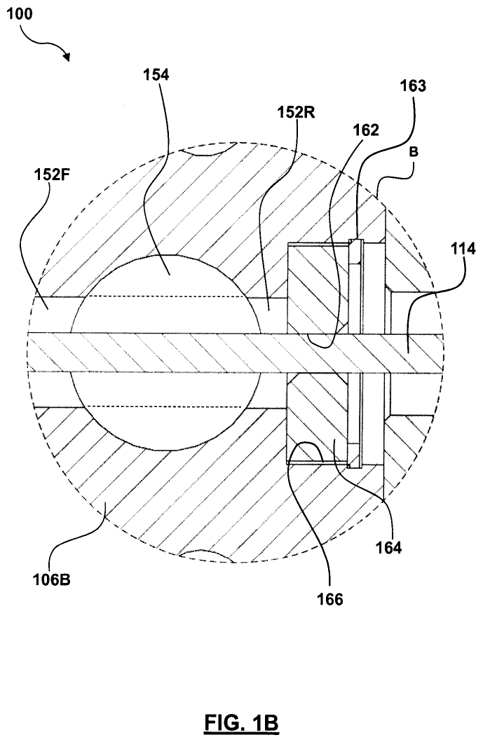

Referring now to FIGS. 1 and 1A in which FIG. 1 is a sectional view of a valve-gating injection molding apparatus 100 in accordance with an embodiment of the present disclosure, and FIG. 1A is a sectional view of valve-gating injection molding apparatus 100 taken along line A-A of FIG. 1. Features and aspects of the current embodiment may be used with the other embodiments disclosed herein. Valve-gating injection molding apparatus 100 includes a valve-gating hot runner system 102 and a plurality of mold plates 106 (such as a manifold plate 106A, a diversion plate 106B, and an actuator plate 106C) forming an enclosure 108 in which valve-gating hot runner system 102 is received. Mold plates 106 can include cooling channels, such as cooling channel 109 on manifold plate 106A. Further, mold plates 106 are held together by fasteners, and may also include additional fastening/aligning components such as guide pins, guide bushings, and the like. While three mold plates are shown, depending on the application, valve-gating injection molding apparatus 100 can include other mold plates. Valve-gating injection molding apparatus 100 can be referred to as a so-called “hot-half” of a hot runner mold. In operation, valve-gating injection molding apparatus 100 is coupled to another mold plate in front of first mold plate 106A, for example, a cavity plate which defines in part the shapes of the mold cavities in which molded articles are formed.

Valve gating hot runner system 102 delivers moldable material to mold cavities. Valve-gating hot runner system 102 includes a manifold 110, a nozzle 112, a valve pin 114, and an actuator 116. Manifold 110 and nozzle 112 include respective manifold and nozzle heaters 118, 120 for maintaining manifold 110 and nozzle 112 at a suitable processing temperature. Enclosure 108 includes a pocket 122 formed in manifold plate 106A and surrounds manifold 110 and an opening 124, also formed in manifold plate 106A and surrounds nozzle 112. Pocket 122 is enclosed by diversion plate 106B. Pocket 122 and opening 124 are sized to form an insulating air gap between manifold 110 and nozzle 112 and mold plates 106. The rearward side of manifold 110 includes a manifold bearing surface 125 which is spaced apart from a bearing surface 126 of diversion plate 106B.

Manifold 110 includes a manifold melt channel 128 for receiving molding material and delivering it to nozzle 112 via a manifold outlet 130. A bore 132 extends across manifold 110 through which valve pin 114 passes. Bore 132 intersects with manifold channel 128 and defines manifold outlet 130. Manifold 110 further includes a pin bore 134 rearward from where valve pin 114 enters manifold channel 128. Together, pin bore 134 and valve pin 114 are slidably fit together and define a sliding interface 135 therebetween. As shown, pin bore 134 is formed within a bushing component 136 received a rearward portion of manifold bore 132.

Nozzle 112 conveys molding material from manifold 110 to a mold cavity (not shown). Nozzle 112 includes a nozzle melt channel 138 that is in fluid communication between manifold channel 128 and a mold cavity via a mold gate G, shown schematically in FIGS. 1 and 1A. Valve pin 114 and nozzle 112 are aligned along a drop axis AD which extends through mold gate G. In viewing FIGS. 1 and 1A, it should be appreciated that valve-gating injection molding apparatus 100 includes four nozzles 112 that are arranged in an array having two rows and two columns.

Valve-gating injection molding apparatus 100 includes a spacer 142 between manifold 110 and diversion plate 106B. Spacer 142 has an opening 144 through which pin 114 extends. In operation, spacer 142 is sandwiched between manifold bearing surface 125 and spacer bearing surface 126 which creates a first face seal between spacer 142 and manifold 110, shown at FS1, and a second face seal between spacer 142 and bearing surface126 shown at FS2.

Opening 144 is sized to receive bushing component 136, which projects beyond the rearward surface of manifold 110. In this configuration pin bore 134 and sealing interface 135 extend rearward beyond manifold bearing surface 125. Opening 144 engages bushing component 136 to locate spacer 142 on manifold 110. Other ways of locating spacer 142 relative to manifold 110 and/or drop axis AD are also contemplated, such as dowels.

Actuator 116 moves valve pin 114 between open and closed positions. Actuator 116 includes a stationary part 146 and a movable part 148 that is energized to move valve pin 114 between its open and closed positions. Stationary part 146 is secured to a mold plate 106, for example, received in a seat 150 that extends through actuator plate 106C, and movable part 148 is coupled to valve pin 114 so that valve pin 114 is movable therewith. Although movable part 148 is shown directly coupled to valve pin 114, movable part 148 can also include one or more intermediate component(s), through which movable part 148 is coupled to valve pin 114. By way of example, actuator 116 is a fluid driven actuator, stationary part 146 is a piston cylinder, and movable part 148 is a piston disposed in piston cylinder.

Valve-gating injection molding apparatus 100 includes a weepage egress passageway or passageway 152 that surrounds valve pin 114 and is spaced apart therefrom. Passageway 152 extends rearward through diversion plate 106B from pin bore 134 towards movable part 148 of actuator 116. Valve-gating injection molding apparatus 100 further includes a diversion chute 154 that intersects pin passageway at an angle 0 and extends towards a perimeter surface 156 of mold plates 106. Ideally, pin bore 134 and valve pin 114 are sized to prevent moldable material from escaping manifold channel 128 through sliding interface 135. However, some situations, for example, molding parts made from a thermoplastic elastomer (TPE) or a thermoplastic olefin (TPO), a change in processing conditions such as molding material viscosity, or wear of the valve pin and/or pin bore, can lead to ingress of molding material into slidable interface 135 and egress of molding material from the pin bore 134. This phenomenon is known in the art of injection molding as weepage. Passageway 152 and diversion chute 154 form a walled conduit, separate from opening 124 and hot runner system 102, for collecting and/or directing weeped molding material, or weepage away from valve-gating hot runner system 102. When valve gating injection molding apparatus 100 is in operation, molding material that egresses from sliding interface 135 is received in egress passageway 152. Accumulation and/or reciprocating movement of valve pin 114 moves the weeped material from passageway 152 to diversion chute 154 where it can collect or exhaust from valve-gating injection molding apparatus 100 away from hot runner system 102 and actuator 116. In other words, passageway 152 and diversion chute 154 provide an enclosed weepage pathway into which molding material that egressed from slidable interface 135 can be deposited.

In the current embodiment passageway 152 and diversion chute 154 are formed within diversion plate106B. Passageway 152 is a bore that extends across the thickness of diversion plate 106B and is spaced apart from valve pin 114. Diversion chute 154 is a bore that extends longitudinally through diversion plate 106B between its opposite facing perimeter surfaces 156, 156′ and bisects weepage passageway 152 at a 90° angle. In this configuration, pin passageway 152 includes two passageway portions, a forward passage portion 152F and a rearward passage portion 152R. Forward passage portion 152F extends from diversion chute 154, through diversion plate 106B to bearing surface 126, and includes a portion of spacer opening 144. Rearward passage portion 152R extends from diversion chute 154, through diversion plate 106B to actuator seat 150. The cross-sectional area of diversion chute 154 as shown in FIG. 1 is at least substantially equal to or greater than the cross-sectional area of passageway 152 as viewed along drop axis AD. While diversion chute 154 is shown as being offset towards bearing surface 126, diversion chute 154 can also be equispaced between the forward and rearward sides of diversion plate 106B. Diversion plate 106B optionally includes cooling channels, such as cooling channels 157 which extend longitudinally on either side of diversion chute 154. Depending on how valve gating injection molding apparatus 100 is mounted in a molding machine, diversion chute 154 can be oriented to extend either vertically or horizontally across diversion plate 106B. For example, in a vertical orientation of diversion chute 154, gravity may assist with evacuating weeped molding material from diversion plate 106B.In embodiments in which valve gating injection molding system 100 has a plurality of nozzles 112, diversion chute 154 can intersect respective egress passageways152 associated with adjacent nozzles 112, such as shown in FIG. 1A.

Diversion chute 154 is capped at its distal ends 158, 158′. While this may be configured in a variety of ways, valve gating injection molding apparatus 100, includes a pair of removable covers plates 160A, 160B that are secured to perimeter surfaces 156, 156′, of mold plates 106, Each cover plate 160A, 160B, blocks a respective distal end 158, 158′ of diversion chute 154. Covers 160A, 160B may be useful in molding applications, for example, clean room molding, where it may be desirable to contain the weeped molding material within mold plates 106 while valve-gating injection molding apparatus 100 is in operation.

Valve-gating injection molding apparatus 100 optionally includes a restrictor 162 (see FIG. 1 A and FIG. 1B, for example). If included, restrictor 162 defines a rearward boundary of passageway 152. Valve pin 114 extends through restrictor 162 which is sized to have a close fit with valve pin 114. Depending on the characteristics of the weeped molding material, for example, its friability and/or adhesion properties, the fit between restrictor 162 and valve pin 114 can be a sliding fit or a running fit.

In some instances, instead of falling into diversion chute, weeped molding material adheres to valve pin 114, and over time is displaced rearward by further weeped material also adhering to valve pin 114. If, instead of being deposited into diversion chute, the adhered weeped molding material reaches restrictor 162, the close-fitting relationship between valve pin 114 and restrictor 162 limits or prevents the adhered weeped material from advancing further rearward towards actuator 116. As valve pin 114 is actuated rearward through restrictor 162, adhered material is pushed forward along valve pin 114 which, along with the reciprocating movement of valve pin 114, can assist with separating the adhered molding material from valve pin 114 and into diversion chute 154 and/or passageway 152.

With reference to FIG. 1B, which is an enlarged view of a portion B of FIG. 1, restrictor 162 is separated from diversion chute 154 by rearward portion 152R of passageway 152. Restrictor 162 is formed in a restrictor component 164 that is coupled to diversion plate 106B. For example, as shown, restrictor component 164 is seated in a counter bore 166 in diversion plate 106B and is retained therein by, for example a snap-ring 163. The width of restrictor component 164 is less than a width of counterbore 166. Restrictor component 164 is made from a material that is softer than valve pin 114 and has sufficient lubricity to facilitate free translation of valve pin 114. By way of example, restrictor component 164 is made from a polymeric material, for example, nylon or PTFE. Restrictor 162 is sized for a close sliding fit with valve pin 114. If valve pin 114 is displaced sideways, the difference between the widths of restrictor component 164 and counterbore 166 allow restrictor component 164 to be displaced with valve pin 114 while limiting or preventing valve pin 114 from side loading restrictor 162. The rearward side of restrictor component 164 is optionally chamfered to facilitate installation of valve pin. The forward side of restrictor component 164 is perpendicular to restrictor 162 to facilitate separating adhered molding material from valve pin 114 when valve pin 114 is translated rearward. Optionally, both sides of restrictor 162 can be either chamfered or perpendicular so that restrictor component 164 can be installed in counter bore 166 in either orientation.

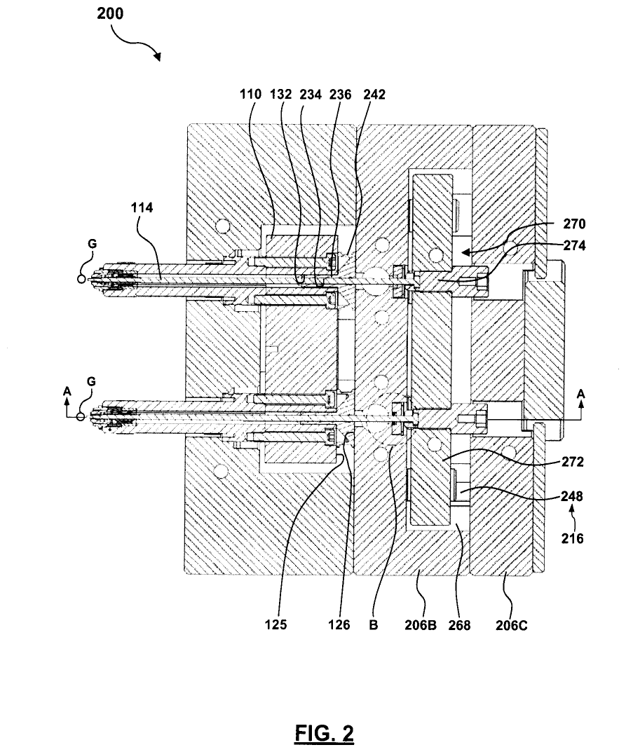

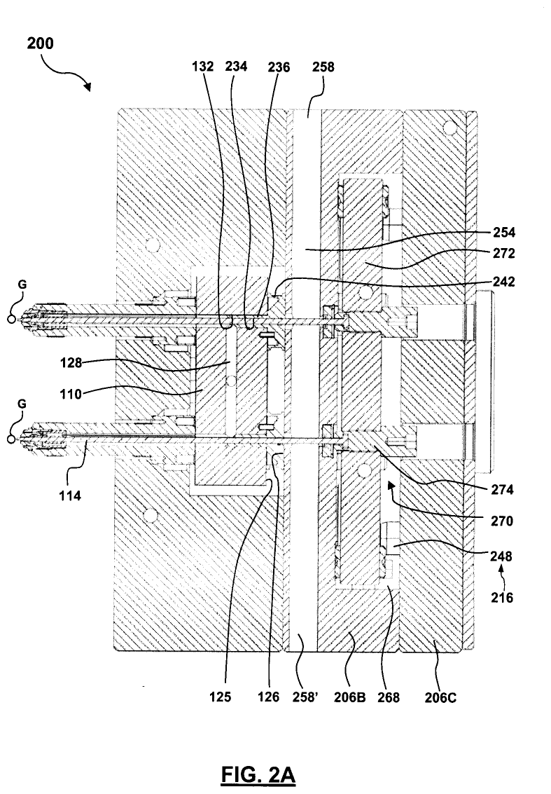

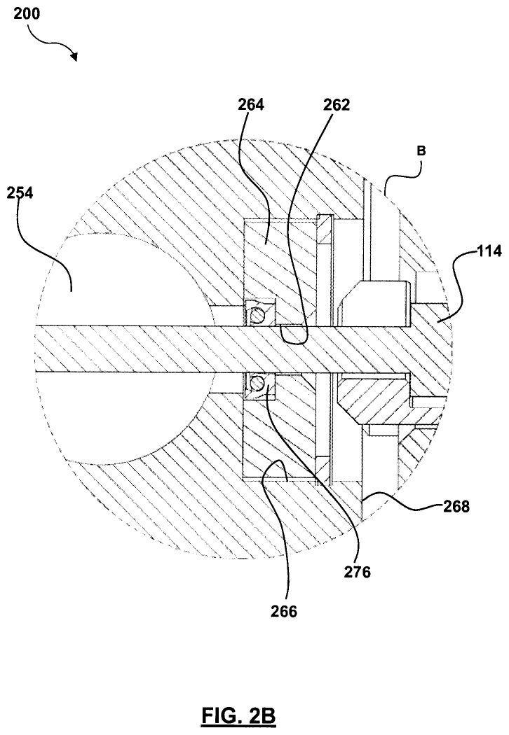

FIG. 2 is a sectional view of a valve-gating injection molding apparatus 200 in accordance with an embodiment of the present disclosure and FIG. 2A is a sectional view of valve-gating injection molding apparatus 200 taken along line A-A of FIG. 2. Features and aspects of the current embodiment may be used with the other embodiments disclosed herein. Valve-gating injection molding apparatus 200 includes a bushing component 236 that is installed in a rearward portion of manifold bore 132 that extends across manifold 110 and intersects with manifold channel 128. A pin bore 234 extends through bushing component 236. A portion of bushing component 236 extends rearward from manifold 110 and defines a spacer 242, which in operation, is sandwiched between manifold bearing surface 125 and bearing surface 126. Bushing component 236 and manifold bore 132 cooperate to locate spacer 242 on manifold 110.

Actuator 216 includes a stationary part (not shown) disposed in actuator plate 206C and a movable part 248 that projects forward through actuator plate 206C into an actuator pocket 268 in diversion plate 206B. Movable part 248 is coupled to valve pin 114 via an intermediate assembly 270. Intermediate assembly 270 includes a valve pin plate 272 that is removably fastened to movable part 248 and a valve pin holder 274, to which valve pin 114 is coupled, which is removably fastened to valve pin plate 272. With this arrangement, when movable part 248 is actuated between open and closed positions, valve pin 114 moves therewith.

As shown in FIG. 2A, distal ends 258, 258′ of diversion chute 254 are open to atmosphere. This configuration may be beneficial for allowing weeped molding material to drop from diversion chute 254 while valve-gating injection molding apparatus 200 is in use.

With reference to FIG. 2B, which is an enlarged view of a portion B of FIG. 2, valve-gating injection molding apparatus 200 includes a restrictor 262 between diversion chute 254 and actuator pocket 268. Restrictor 262 is formed in a restrictor component 264 that is seated in a counter bore 266 at the bottom of actuator pocket 268. The forward side of restrictor component 264 includes a recess in which a U-seal 276 is disposed. U-seal 276 forms a close sliding fit with valve pin 114 and, depending on the friability and adhesion properties of adhered weeped molding, can be beneficial for separating the adhered molding material from valve pin 114.

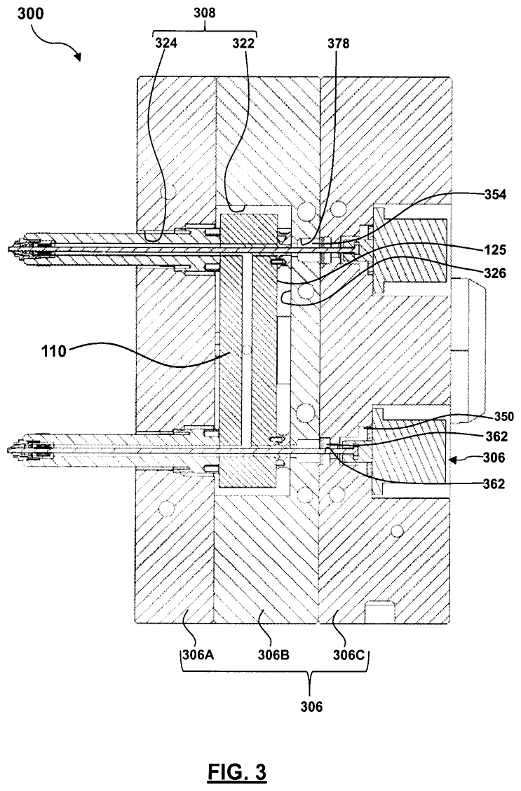

FIG. 3 is a sectional view of a valve-gating injection molding apparatus 300 in accordance with another embodiment of the present disclosure. Features and aspects of the current embodiment may be used with the other embodiments disclosed herein. Valve-gating injection molding apparatus 300 includes mold plates 306 (such as a nozzle plate 306A, a manifold plate 306B, and an actuator plate 306C) that defines an enclosure 308 in which valve-gating hot runner system 302 is received. Enclosure 308 includes a pocket 322 formed in manifold plate 306B that surrounds manifold 110 and an opening 324 formed in nozzle plate 306A that surrounds nozzle 112. Nozzle plate 306A encloses pocket 322. The rearward side of manifold 110 includes a manifold bearing surface 125 that is spaced apart from a bearing surface 326 which is defined by manifold plate 306B

Valve-gating injection molding apparatus 300 includes a trough 378 in the rearward surface of manifold plate 306B which, together with the forward surface of actuator plate 306C, forms diversion chute 354. Diversion chute 354 has a rectangular cross-sectional shape. Actuator plate 306 can be separated from manifold plate 306B to expose trough 378 and restrictor 362, which may be useful for servicing diversion chute 354 and/or restrictor 362.

Valve-gating injection molding apparatus 300 includes restrictor 362 between diversion chute 354 and actuator 316 which opens directly into diversion chute 354. Restrictor 362 is defined by a restrictor component, for example restrictor component 162 which is seated in a counter bore 366 in the forward surface of actuator plate 306C. In an alternative embodiment, restrictor 362 is defined by a bore that extends rearward through actuator plate 306C to actuator seat 350.

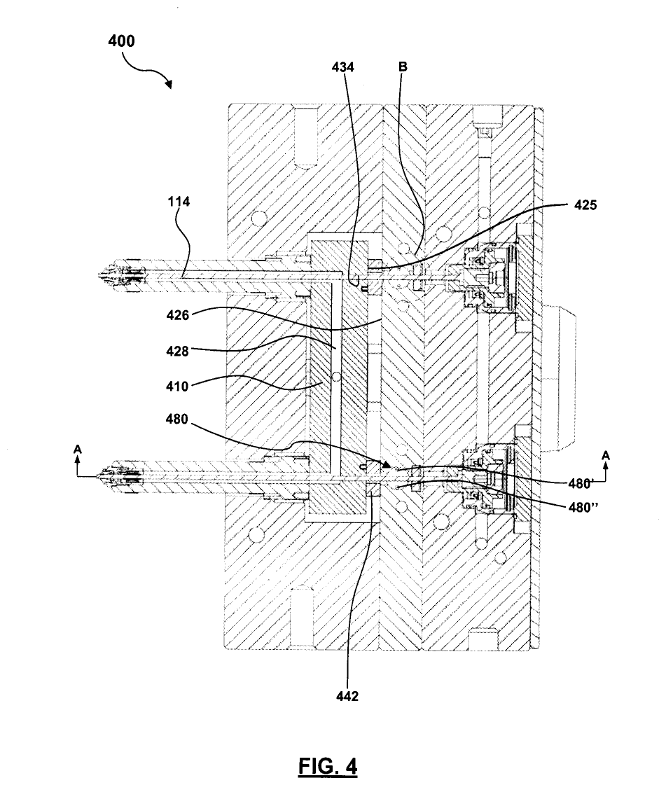

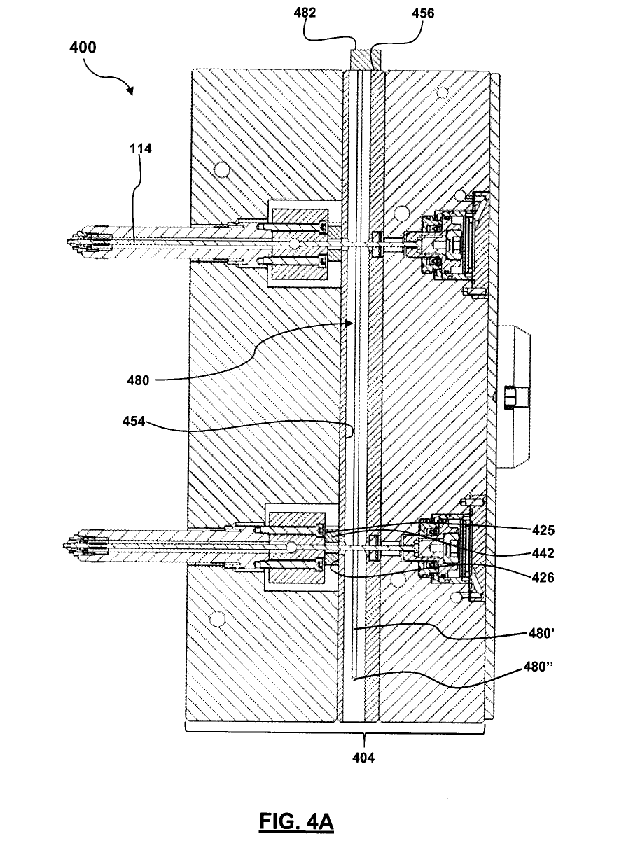

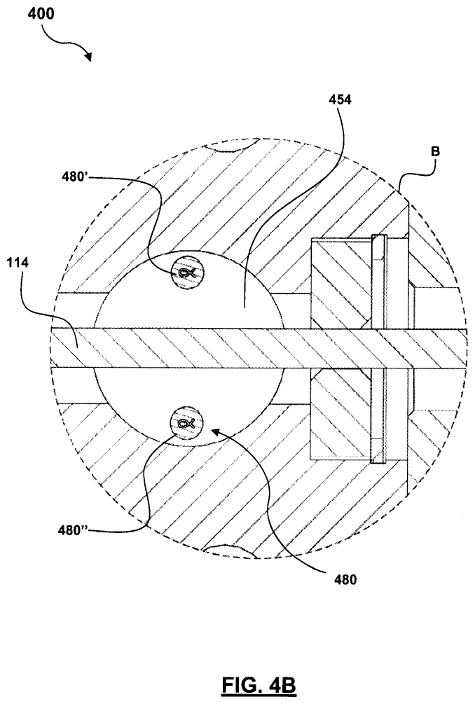

Referring now to FIGS. 4, 4A, and 4B in which FIG. 4 is a sectional view of a valve-gating injection molding apparatus 400 in accordance with an embodiment of the present disclosure, FIG. 4A is a sectional view of valve-gating injection molding apparatus 400 taken along line A-A of FIG. 4, and FIG. 4B is an enlarged view of a portion B of FIG. 4. Features and aspects of the current embodiment may be used with the other embodiments disclosed herein. Valve-gating injection molding apparatus 400 includes a heater 480 within diversion chute 454. While configurable in a variety of ways, heater 480 is an elongate “U-shaped resistance wire element heater suspended in diversion chute 454. Heater 480 includes two arm portions 480′, 480″, one on each side of valve pin 114, that are connected together by a base portion 480′” (see FIG. 4A). Heater 480 is coupled to support structure 404 so as to maintain the position of heater 480 within diversion chute 454. By way of example, this is accomplished by attaching the distal ends of arm portions 480′, 485″ to a securing member 482 which is removably fastened to a top perimeter surface 456 of support structure 404. While not necessarily used while valve-gating injection molding apparatus 400 is in operation, heater 480 may be useful to assist with evacuating weeped material from diversion chute 454 when valve-gating injection molding apparatus 400 is not in use. For example, if weeped molding material is adhered to valve pin 114 and/or a wall of diversion chute 454, heater 480 can be activated to soften or melt the weeped molding material, which may then fall from diversion chute 454, away from valve-gating injection molding apparatus 400.

Valve-gating injection molding apparatus 400 includes a pin bore 434 formed directly in manifold 410 and extends through manifold 410 from the rearward surface of manifold 410 to manifold channel 428.

Valve-gating injection molding apparatus 400 includes a spacer 442, which in operation is sandwiched between manifold bearing surface 425 and diversion plate bearing surface 426. Spacer 442 has an opening 444 that extends therethrough. The diameter of opening 444 is larger than pin bore 434 and is substantially equal to or smaller than passageway 452. Pin bore 434 and passageway 452 open into spacer opening 444. With this configuration, passageway 452 can be described as an enclosed weepage channel that extends from diversion chute 454 to the rearward surface of manifold 410.

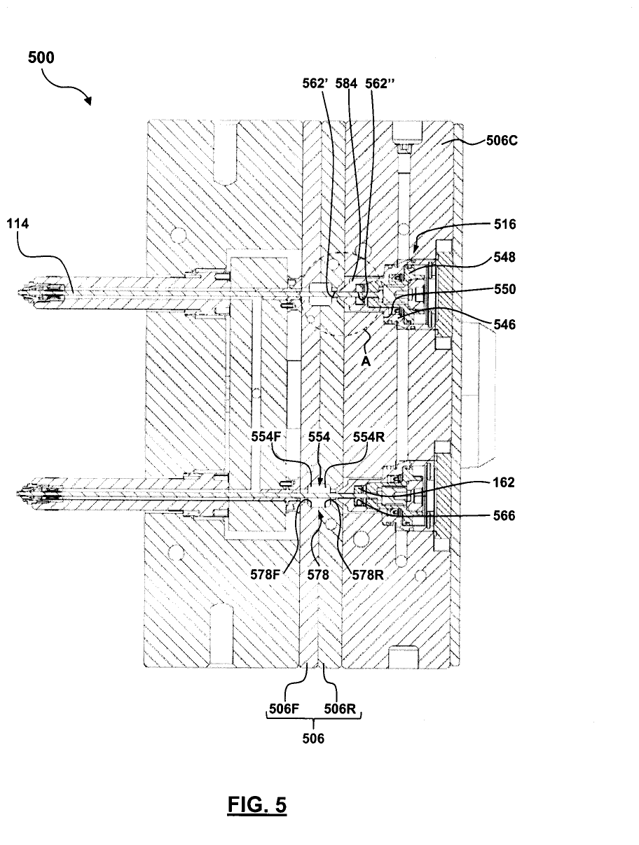

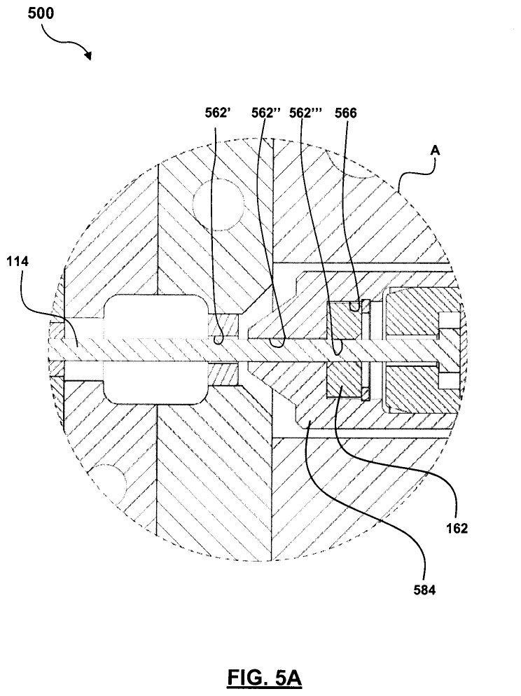

Referring now to FIGS. 5 and 5A in which FIG. 5 is a sectional view of a valve-gating injection molding apparatus 500 in accordance with another embodiment of the present disclosure, and FIG. 5A is an enlarged view of a portion A of FIG.5. Features and aspects of the current embodiment may be used with the other embodiments disclosed herein. Valve-gating injection molding apparatus 500 includes a diversion plate assembly 506 having a forward diversion plate 506F and a rearward diversion plate 506R that are fastened together. Diversion chute 554 includes a forward chute portion 554F formed as a trough 578 in forward diversion plate 506F and a rearward chute portion 554R formed as a trough 578 in rearward diversion plate 506R. In this configuration, diversion chute can be described as being formed between adjacent plate portions 506F, 506R. Diversion plate assembly 506 can be separated to expose forward and rearward chute portions 554F, 554R, which may be useful for servicing diversion chute 554.

Valve-gating injection molding apparatus 500 includes a primary restrictor 562′ formed as a bore in rearward diversion plate 506B that opens into diversion chute 554. Primary restrictor 562′ is sized so as to so as to limit or prevent wear of valve pin 114 and/or primary restrictor 562′ during normal operation.

Valve-gating injection molding apparatus 500 includes an actuator 516 having a stationary part 546 secured within a seat 550 in actuator plate 506C. Stationary part 546 is shaped to receive movable part 548 therein and includes an extension portion 584 that projects forward beyond movable part 548. Extension portion 584 defines a secondary restrictor 562″ between primary restrictor 562′ and movable part 548. Extension portion 584 optionally includes a tertiary restrictor 562′″ between secondary restrictor 562′ and movable part 548. As shown, tertiary restrictor 562′″ is defined by a restrictor component, for example restrictor component 162 which is seated in a counter bore 566 in extension portion. Secondary restrictor 562″ and optional tertiary restrictor 562′″ may limit or weeped molding material from entering actuator 516 and interfering with actuation of movable part 548.

While various embodiments have been described above, it should be understood that they have been presented only as illustrations and examples, and not by way of limitation. It will be apparent to persons skilled in the relevant art that various changes in form and detail can be made therein without departing from the scope of the invention. Thus, the present invention should not be limited by any of the above-described exemplary embodiments but should be defined only in accordance with the appended claims and their equivalents.

1. A valve gating injection molding apparatus comprising:
a manifold having a manifold channel extending therethrough;
a nozzle coupled to the manifold and having a nozzle channel in fluid communication with the manifold channel;
a valve pin extending across the manifold and through the nozzle channel;
an actuator coupled to the valve pin for translating the valve pin between open and closed positions; and
a plurality of mold plates forming an enclosure to house the manifold, the plurality of mold plates defining an egress passageway through which the valve pin extends and a diversion chute that intersects the egress passageway at an angle.

2. The valve gating injection molding apparatus of claim 1 wherein a cross-sectional area of the egress passageway is equal to or greater than a cross-sectional area of the diversion chute.

3. The valve gating injection molding apparatus of claim 1 wherein the diversion chute is oriented so that gravity can assist with evacuating weeped molding material from the diversion chute.

4. The valve gating injection molding apparatus of claim 1 wherein the diversion chute includes opposite open ends capped by respective cover plates.

5. The valve gating injection molding apparatus of claim 1 further comprising a restrictor component defining a restrictor, through which the valve pin extends, the restrictor sized to have a sliding fit with the valve pin, the restrictor positioned upstream of the diversion chute.

6. The valve gating injection molding apparatus of claim 5 further including a snap-ring retaining the restrictor component in position.

7. The valve gating injection molding apparatus of claim 6 wherein the restrictor is chamfered.

8. The valve gating injection molding apparatus of claim 7 wherein the restrictor is made of nylon.

9. The valve gating injection molding apparatus of claim 7 wherein the restrictor is made of Polytetrafluoroethylene (PTFE).

10. The valve gating injection molding apparatus of claim 1 further including a bushing component defining a valve pin through bore, through which the valve pin extends, the plurality of mold plates including a diversion plate positioned upstream of the manifold, and the diversion plate capping an upstream side of the enclosure, the bushing component including a spacer sandwiched between the manifold and the diversion plate.

11. The valve gating injection molding apparatus of claim 10 further comprising a restrictor component defining a restrictor, through which the valve pin extends, the restrictor sized to have a sliding fit with the valve pin, the restrictor positioned upstream of the diversion chute.

12. The valve gating injection molding apparatus of claim 11 further comprising a u-seal disposed in a recess in a downstream portion of the restrictor component, the u-seal defining another valve pin through bore, through which the valve pin extends, and the another valve pin through bore forming a sliding fit with the valve pin.

13. The valve gating injection molding apparatus of claim 1 wherein the diversion chute has a rectangular cross-sectional shape.
